(19) United States
(12) Patent Application Publication
(10) Pub. No.: US 2010/0263805 A1
(43) Pub. Date: Oct. 21, 2010

(54) SLATS CONTROL SYSTEM FOR BLINDS

(76) Inventors: WEN YING LIANG, Fuxing Shiang (TW); Sheng Ying Hsu, Fuxing Shiang (TW)

Correspondence Address: PHILLIP LIU, 6980, WHITEOAK Dr., RICHMOND, BC, V7E4Z9, CA

(21) Appl. No.: 12/425,356

(22) Filed: Apr. 16, 2009

(51) Int. Cl. E06B 9/30

(52) U.S. Cl. 160/168.1 R

(57) ABSTRACT

A slats control system for blinds includes a first control rope and a second control rope. Two respective first ends of the two control ropes are fixed to the control members corresponding thereto and the axis of the control member is located between the first control rope and the second control rope. Multiple odd-numbered slats and even-numbered slats are connected to the head box. Multiple connection ropes extend through the slats and are connected between the head box and a bottom bar. A first/second driving rope is transversely connected to an underside of the odd-numbered slat/even-numbered slat. The first/second control ropes are connected to the first/second driving ropes on each slat. When the control members are rotated by rotating a shaft, the first/second control rope and the second/first control rope are lifted and the lowered simultaneously. The odd-numbered slats and the even-numbered slats are rotated in opposite directions simultaneously.

### FIELD OF THE INVENTION

The present invention relates to blinds, and more particularly, to a slats control system for blinds, wherein the slats are alternatively rotated in opposite directions.

### BACKGROUND OF THE INVENTION

A conventional slats control system for blinds generally includes a shaft which is connected with plurality of passive members and control ropes are connected with the passive members. The users can operate the shaft which rotates the passive members and the control ropes are then lifted or loosened. The control ropes are connected to the slats which are able to be operated to rotate at desired angles. However, the conventional slats control system can only adjust the angles of the slats, and all of the slats are rotated in the same directions and to the same angle. This type of operation and movement of the slats gradually cannot meet requirements of the users.

The present invention intends to provide a slats control system for blinds wherein the odd-numbered slats and the even-numbered slats are respectively controlled by two control ropes which are driven in opposite directions so that the odd-numbered slats and the even-numbered slats are rotated in opposite directions.

### SUMMARY OF THE INVENTION

The present invention relates to a slats control system for blinds and comprises a head box with a driving box received in a chamber of the head box. An operation wand is pivotably connected to the driving box. A control unit is received in the chamber and includes a plurality of frames to which control members are connected respectively. Each one of the control members is connected to two respective first ends of a first control rope and a second control rope, and an axis of each of the control members is located between the first control rope and the second control rope. A shaft extends through the control members and rotating the control members. A slat unit is connected to an underside of the head box and includes odd-numbered slats and even-numbered slats. Multiple connection ropes have first ends connected to the slats control system and second ends of the connection ropes extend through the odd-numbered slats and the even-numbered slats and are fixed to a bottom bar. Each odd-numbered slat has a first driving rope transversely connected to an underside thereof and the first control rope is connected to the first driving ropes of the odd-numbered slats. Each even-numbered slat has a second driving rope transversely connected to an underside thereof and the second control rope is connected to the second driving ropes of the even-numbered slats. When the shaft rotates, the control members are rotated with the shaft so as to lift the first/second control rope and lower the second/first control rope simultaneously.

The primary object of the present invention is to provide a slats control system so as to control the odd-numbered slats and even-numbered slats simultaneously in two opposite directions.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is a perspective view to show the slats control system of the present invention;

FIG. 2 is an exploded view to show the slats control system of the present invention;

FIG. 3 is an end view to show the first and second ropes connected to the control member of the slats control system of the present invention;

FIG. 4 shows that the connection ropes lift the slats;

FIG. 5 shows that the odd-numbered slats and the even-numbered slats are rotated in opposite directions wherein the control member is rotated clockwise;

FIG. 6 is an end view to show that the control member is rotated clockwise when the slats are rotated as shown in FIG. 5;

FIG. 7 shows that the odd-numbered slats and the even-numbered slats are rotated in opposite directions wherein control member is rotated counter clockwise, and

FIG. 8 is an end view to show that the control member is rotated counter clockwise when the slats are rotated as shown in FIG. 7.

### DETAILED DESCRIPTION OF THE PREFERRED EMBODIMENT

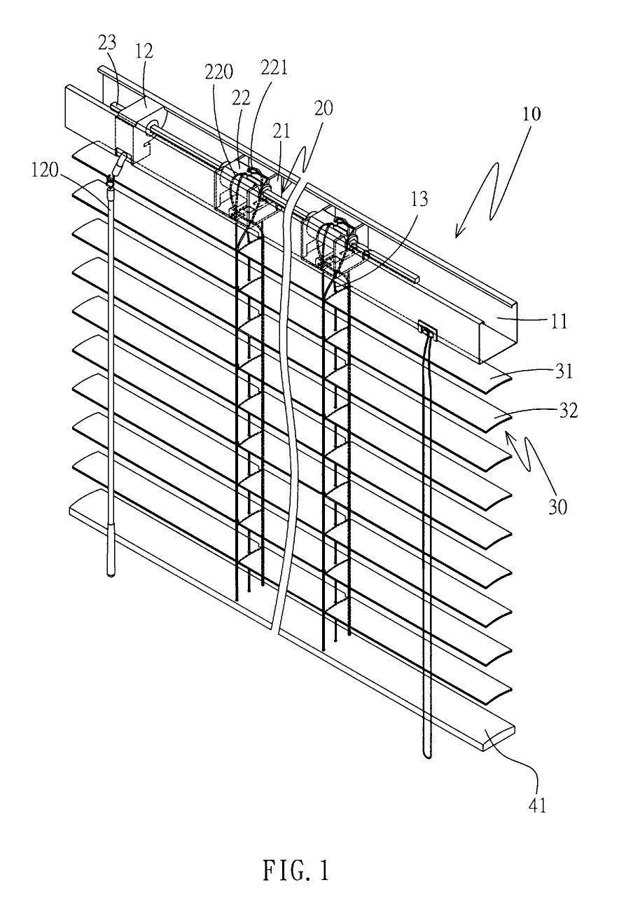

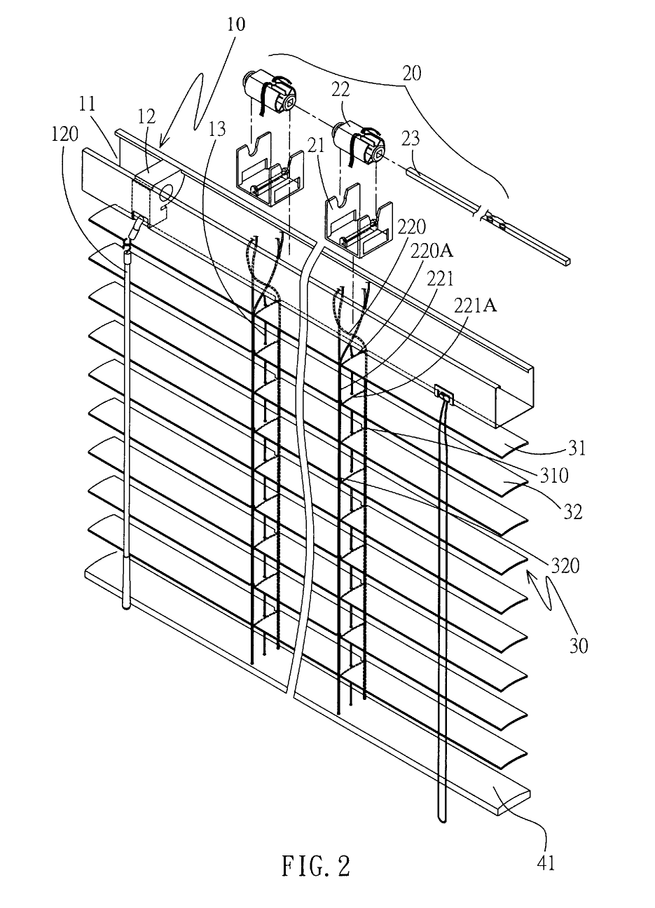

Referring to FIGS. 1 to 3, the slats control system for blinds of the present invention comprises a head box 10 having a chamber 11 defined therein and a driving box 12 is received in the chamber 11 and located at one end of the head box 10. An operation wand 120 is pivotably connected to the driving box 12.

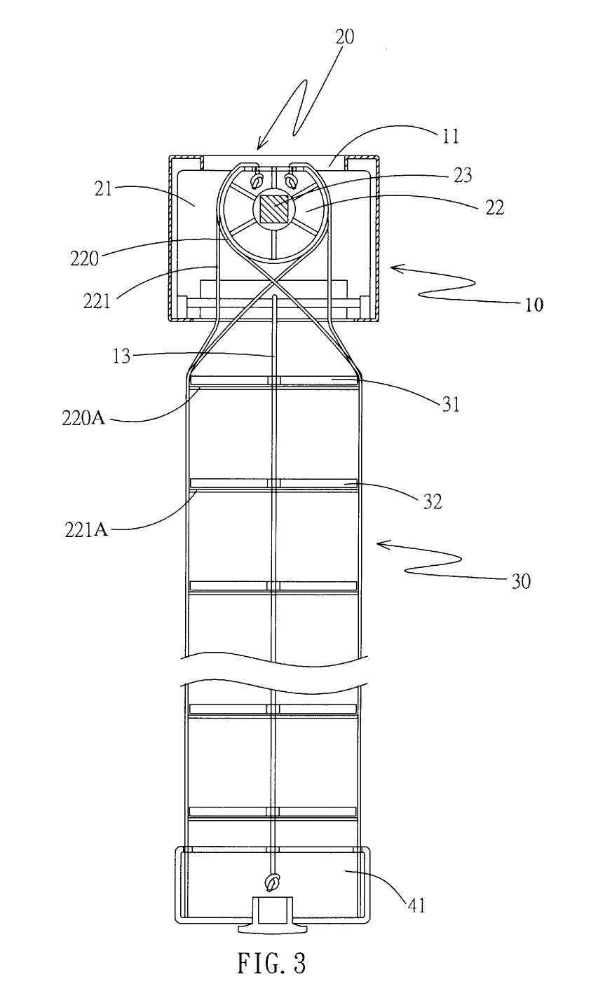

A control unit 20 is received in the chamber 11 in the head box 10 and includes a plurality of frames 21 and control members 22 are connected to the frames 21 respectively. A shaft 23 extends through the control members 22 and rotating the control members 22. Each one of the control members 22 is connected to two respective first ends of a first control rope 220 and a second control rope 221 as shown in FIG. 3. An axis of each of the control members 22 is located between the first control rope 220 and the second control rope 221.

A slat unit 30 is connected to an underside of the head box 10 and includes odd-numbered slats 31 and even-numbered slats 32, and a bottom bar 41 is connected to the lower end of the slat unit 30. Multiple connection ropes 13 have first ends thereof connected to the slats control system and second ends of the connection ropes 13 extend through the odd-numbered slats 31 and the even-numbered slats 32 and are fixed to the bottom bar 41.

Each odd-numbered slat 31 has a first recess 310 defined in a first side thereof and a first driving rope 220A is transversely connected to an underside of each odd-numbered slat 31. The first control rope 220 is connected to the first driving ropes 220A of the odd-numbered slats 31 at the first recesses 310 of the odd-numbered slats 31. Each even-numbered slat 32 has a second recess 320 defined in a second side thereof and a second driving rope 221A is transversely connected to an underside of each even-numbered slat 32. The second control rope 221 is connected to the second driving ropes 221A of the even-numbered slats 32 at the second recesses 320. The first and second sides are located opposite to each other.

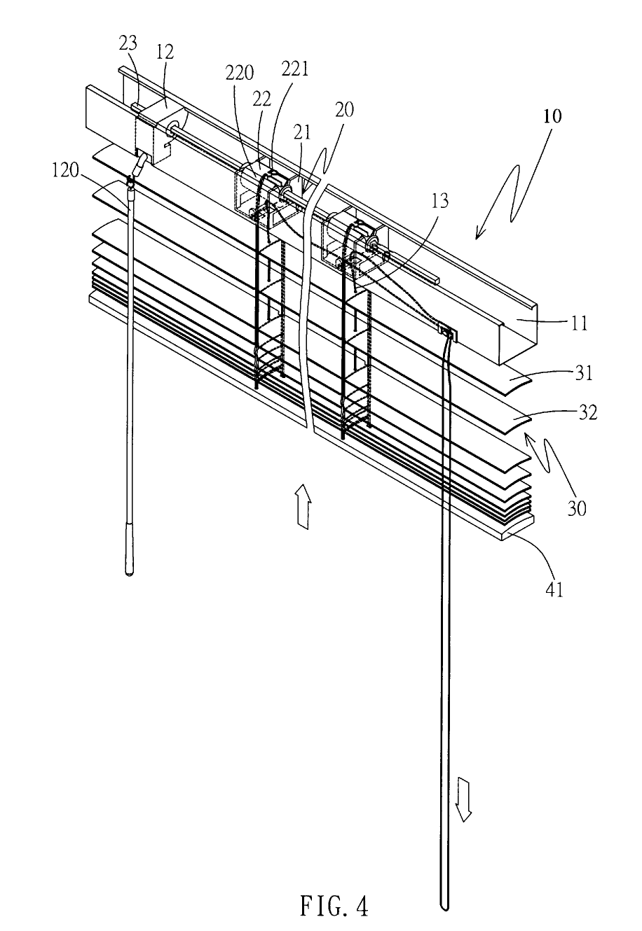

As shown in FIG. 4, when the user operates the slats control system by pulling the lifting ropes (not numbered) on the right of the head box 10 downward, the connection ropes 13 lift the bottom bar 41 upward to collect the odd-numbered slats 31 and the even-numbered slats 32.

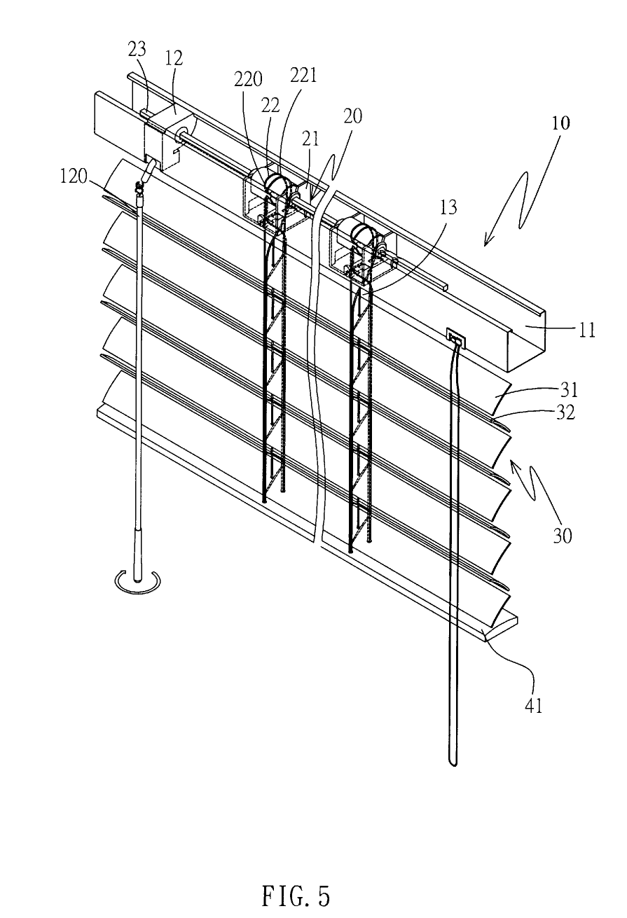

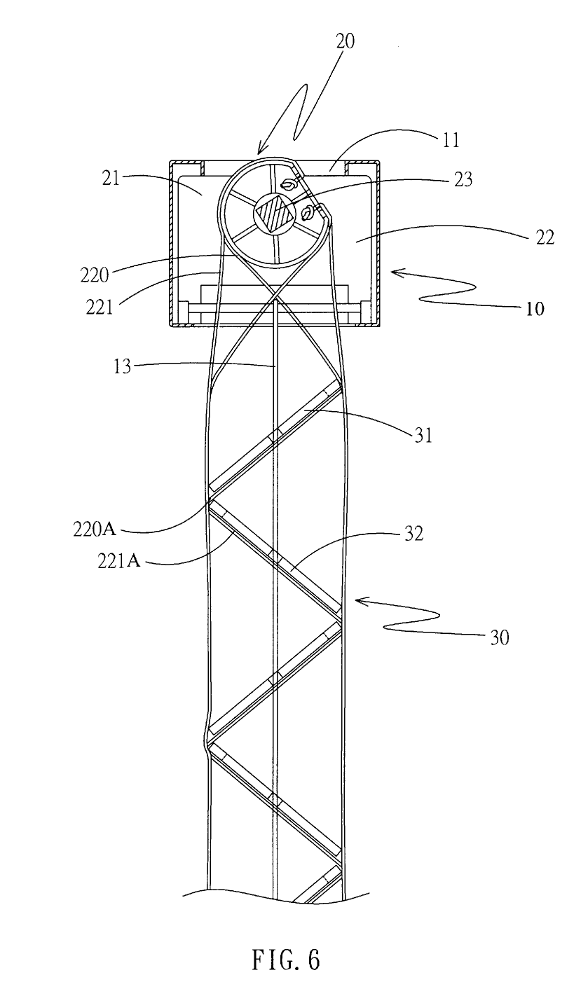

As shown in FIGS. 5 and 6, when the user rotates the operation wand 120 clockwise, the shaft 23 rotates and the control members 22 are rotated with the shaft 23. The first control rope 220 and the second control rope 221 are lifted and lowered simultaneously. The odd-numbered slats 31 are pivoted about the connection ropes 13 which extends through a center of the odd-numbered slats 31, the left ends of the odd-numbered slats 31 are lowered and the right ends of the odd-numbered slats 31 are raised as shown in FIG. 6. Simultaneously, the even-numbered slats 32 are pivoted about the connection ropes 13 which extend through a center of the eve-numbered slats 32. The left ends of the even-numbered slats 32 are raised and the right ends of the even-numbered slats 32 are lowered.

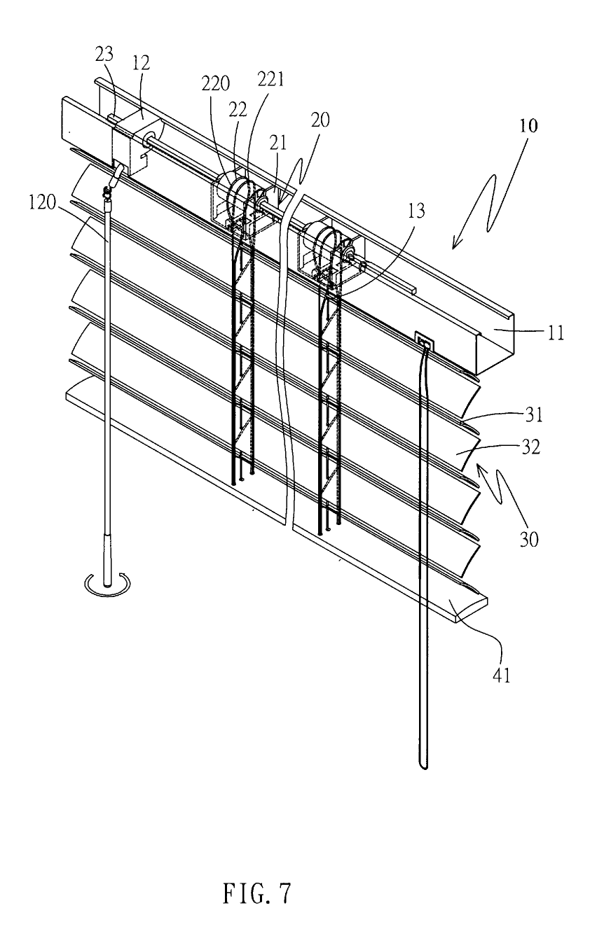

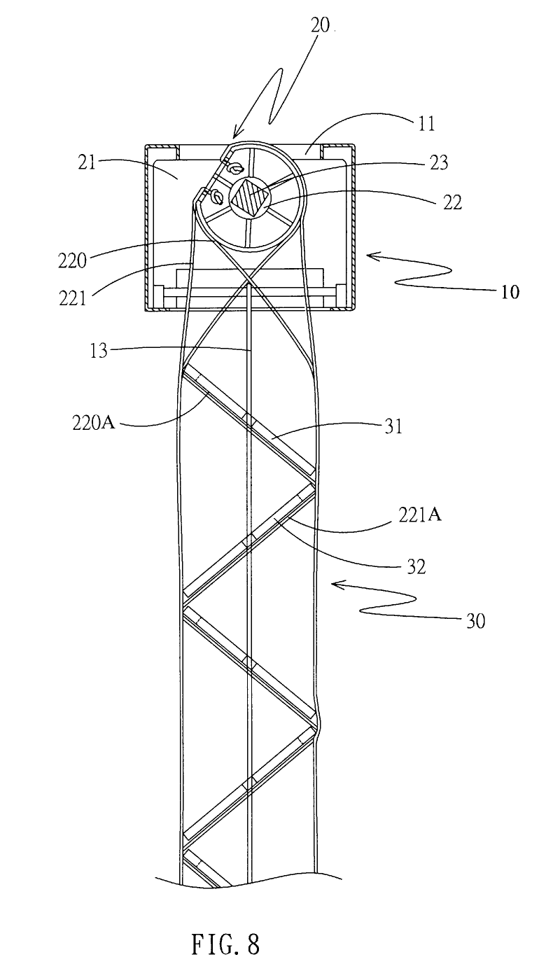

As shown in FIGS. 7 and 8, when the user rotates the operation wand 120 counter clockwise, the shaft 23 rotates in another direction and the control members 22 are rotated with the shaft 23. The first control rope 220 and the second control rope 221 are lowered and lifted simultaneously. The odd-numbered slats 31 are pivoted about the connection ropes 13 which extends through the center of the odd-numbered slats 31, the left ends of the odd-numbered slats 31 are lifted and the right ends of the odd-numbered slats 31 are lowered as shown in FIG. 8. Simultaneously, the even-numbered slats 32 are pivoted about the connection ropes 13 which extend through the center of the eve-numbered slats 32. The left ends of the even-numbered slats 32 are lowered and the right ends of the even-numbered slats 32 are raised.

The slats control system provides a function that can pivot the odd-numbered slats 31 and the even-numbered slats 32 in opposite directions simultaneously. The two sides of the odd-numbered slats 31 and the even-numbered slats 32 may have printed patterns so that when the operation wand 120 is rotated clockwise, a specific scene can be seen on the blinds, and when the operation wand 120 is rotated counter clockwise, another scene can be seen on the blinds.

While we have shown and described the embodiment in accordance with the present invention, it should be clear to those skilled in the art that further embodiments may be made without departing from the scope of the present invention.

What is claimed is:

1. A slats control system for blinds, comprising:
a control unit received in a chamber defined in a head box and including a plurality of frames, control members connected to the frames respectively, each one of the control members connected to two respective first ends of a first control rope and a second control rope and an axis of each of the control members located between the first control rope and the second control rope, a shaft extending through the control members and rotating the control members, and
a slat unit connected to an underside of the head box and including odd-numbered slats and even-numbered slats, multiple connection ropes having first ends connected to the slats control system and second ends of the connection ropes extending through the odd-numbered slats and the even-numbered slats and fixed to a bottom bar located at a lower end of the slat unit, each odd-numbered slat having a first driving rope transversely connected to an underside thereof and the first control rope connected to the first driving ropes of the odd-numbered slats, each even-numbered slat having a second driving rope transversely connected to an underside thereof and the second control rope connected to the second driving ropes of the even-numbered slats, when the shaft rotates, the control members are rotated with the shaft so as to lift the first/second control rope and lower the second/first control rope simultaneously.

2. The system as claimed in claim 1, wherein each odd-numbered slat has a first recess defined in a first side thereof and each even-numbered slat has a second recess defined in a second side thereof, the first and second sides are located opposite to each other, the first control ropes are fixed to the first recesses of the odd-numbered slats and the second control ropes are fixed to the second recesses of the even-numbered slats.

3. A slats control system for blinds, comprising:
a head box having a chamber defined therein and a driving box received in the chamber, an operation wand pivotably connected to the driving box;
a control unit received in the chamber in the head box and including a plurality of frames, control members connected to the frames respectively, each one of the control members connected to two respective first ends of a first control rope and a second control rope and an axis of each of the control members located between the first control rope and the second control rope, a shaft extending through the control members and rotating the control members, and
a slat unit connected to an underside of the head box and including odd-numbered slats and even-numbered slats, multiple connection ropes having first ends connected to the slats control system and second ends of the connection ropes extending through the odd-numbered slats and the even-numbered slats and fixed to a bottom bar located at a lower end of the slat unit, each odd-numbered slat having a first driving rope transversely connected to an underside thereof and the first control rope connected to the first driving ropes of the odd-numbered slats, each even-numbered slat having a second driving rope transversely connected to an underside thereof and the second control rope connected to the second driving ropes of the even-numbered slats, when the shaft rotates, the control members are rotated with the shaft so as to lift lower the first/second control rope and lower the second/first control rope simultaneously.

4. The system as claimed in claim 3, wherein each odd-numbered slat has a first recess defined in a first side thereof and each even-numbered slat has a second recess defined in a second side thereof, the first and second sides are located opposite to each other, the first control ropes are fixed to the first recesses of the odd-numbered slats and the second control ropes are fixed to the second recesses of the even-numbered slats.
